(19) United States
(12) Patent Application Publication
(10) Pub. No.: US 2013/0143585 A1
(43) Pub. Date: Jun. 6, 2013

(54) METHOD AND APPARATUS FOR GEOLOCATING A WIRELESS COMMUNICATION UNIT

(71) Applicants: Peter Kenington, Devauden (GB); Nicholas James Randell, Blacknest (GB)

(72) Inventors: Peter Kenington, Devauden (GB); Nicholas James Randell, Blacknest (GB)

(21) Appl. No.: 13/310,223

(22) Filed: Dec. 2, 2011

(51) Int. Cl. H04W 24/00

(52) U.S. Cl. 455/456.1

(57) ABSTRACT

A method for geolocating a wireless communication unit. The method comprises receiving identifiers for at least two wireless coverage areas visible to the wireless communication unit, obtaining crowd-sourced geographical data for the at least two identified wireless coverage areas, and calculating a geolocation estimate for the wireless communication unit based at least partly on the obtained crowd-sourced geographical data for the at least two identified wireless coverage areas.

### FIELD OF THE INVENTION

The field of the invention relates to a method and apparatus for geolocating a wireless communication unit, and in particular to a method and apparatus for geolocating a wireless communication unit within a cellular communication network.

### BACKGROUND OF THE INVENTION

Wireless communication systems, such as the 2^{nd} Generation (2G) (otherwise referred to as Global System for Mobile (GSM) communications) and the 3^{rd} Generation (3G) of mobile telephone standards and technology, are well known. An example of such 3G standards and technology is the Universal Mobile Telecommunications System (UMTS), developed by the 3^{rd} Generation Partnership Project (3GPP) (www.3gpp.org).

Typically, wireless communication units, or User Equipment (UE) as they are often referred to in 3G parlance, communicate with a Core Network (CN) of the 3G wireless communication system via a Radio Network Subsystem (RNS). A wireless communication system typically comprises a plurality of radio network subsystems, each radio network subsystem comprising one or more base stations, each base station supporting one or more communication cells to which UEs may attach, and thereby connect to the network.

The practice of geolocation, in relation to such wireless communication systems, is the identification of a real-world geographical location of a wireless communication unit. Geolocation may be used for various different purposes ranging from, by way of example, enabling emergency services to determine the location of a caller during an emergency call, to enabling network coverage, quality of service and other similar wireless communication unit related data to be evaluated.

A number of techniques for performing geolocation of wireless communication units in a wireless communication system have been developed. One such technique involves the installation of dedicated hardware at each base station site, as currently implemented for ‘E911’ emergency call location in the United States of America. Such a technique enables a high level of accuracy for geographically locating a wireless communication unit. However, the installation of such additional, dedicated hardware is expensive to implement.

Another technique uses GPS (Global Position Satellite) functionality built into wireless communication units. This technique also enables a high level of accuracy for geographically locating a wireless communication unit. However, this technique relies on the wireless communication unit being located to have a GPS receiver, and for that GPS receiver to be turned on. Even if a GPS receiver is present, many users leave them turned off due to privacy concerns and/or to prolong battery life.

A further technique uses signal strength and timing data derived from the wireless communication unit itself, along with network configuration data provided by the network operator, to locate the wireless communication unit. One such technique is described in the applicants co-pending patent application WO2010/083943. Advantageously, this technique does not require additional dedicated hardware to be implemented within the network, nor does it required GPS functionality to be available within the wireless communication unit being located. However, a problem with such a technique is that it relies on signal strength and timing data provided by wireless communication units, which are consumer grade devices built to a budget, and which typically do not undergo regular calibration. Furthermore, such consumer units often experience rough treatment such as being dropped on hard surfaces etc. As such, the data received from wireless communication units can be unreliable, and may even be entirely inaccurate. A further problem with such a technique is that it relies on network configuration data provided by the network operator; such data often being out of date or simply inaccurate.

Thus, there is a need for an improved method and apparatus for geolocating a wireless communication unit, whereby at least some of the above mentioned problems with known techniques are substantially alleviated.

### SUMMARY OF THE INVENTION

Accordingly, the invention seeks to mitigate, alleviate or eliminate one or more of the abovementioned disadvantages singly or in any combination.

According to a first aspect of the invention, there is provided a method for geolocating a wireless communication unit. The method comprises receiving identifiers for at least two wireless coverage areas visible to the wireless communication unit, obtaining crowd-sourced geographical data for the at least two identified wireless coverage areas, and calculating a geolocation estimate for the wireless communication unit based at least partly on the obtained crowd-sourced geographical data for the at least two identified wireless coverage areas.

The use of crowd-sourced data in this manner enables a wireless communication unit to be geolocated without the requirement for additional dedicated hardware to be implemented within the cellular communication network, and without requiring GPS functionality to be available within the wireless communication unit. In addition, such a technique does not rely on measurements such as signal strength, link quality, timing data, etc. provided by the wireless communication units, which may sometimes be unreliable due to the wireless communication units being consumer grade devices built to a budget, and which typically do not undergo regular calibration. Furthermore, such a technique does not rely on network configuration data provided by the network operator; such data often being out of date or simply inaccurate.

In one optional embodiment of the invention, the method may further comprise calculating an area of overlap of the wireless coverage areas based on the crowd-sourced geographical data therefor, and determining a geolocation estimate for the wireless communication unit within the area of overlap. For example, the method may comprise determining a geolocation estimate for the wireless communication unit to be a central point within the overlap of the wireless coverage areas. Alternatively, the method may comprise determining a geolocation estimate for the wireless communication unit to be an arbitrary point within the overlap of the wireless coverage areas.

In one optional embodiment of the invention, the method may further comprise refining a geolocation estimate for the wireless communication unit using measurements for at least one of the identified wireless coverage areas provided by the wireless communication unit. For example, the method may comprise receiving signal strength information from the wireless communication unit for at least one of the identified wireless coverage areas, and refining the geolocation estimate for the wireless communication unit within the area of overlap based at least partly on the received signal strength information. Additionally/alternatively, the method may further comprise receiving link quality information from the wireless communication unit for at least one of the identified wireless coverage areas, and refining the geolocation estimate for the wireless communication unit within the area of overlap based at least partly on the received link quality information. Additionally/alternatively, the method may further comprise receiving propagation delay information from the wireless communication unit for at least one of the identified wireless coverage areas, estimating a distance between the wireless communication unit and a transmitter of the at least one identified wireless coverage area for which propagation delay information is received, and refining the geolocation estimate for the wireless communication unit within the area of overlap based at least partly on the estimated distance(s).

In this manner, measurements such as signal strength, link quality, timing data, etc. may be used to augment the use of crowd-sourced data to geolocate the wireless communication unit.

In one optional embodiment of the invention, the crowd-sourced geographical data for the identified wireless coverage areas may comprise, for each wireless coverage area, an indication of a geographical location representative of a central point within the wireless coverage area, and an indication of a radius of the wireless coverage area.

In one optional embodiment of the invention, the crowd-sourced geographical data for the identified wireless coverage areas may be obtained from at least one third party database. For example, the crowd-sourced geographical data for the identified wireless coverage areas may be obtained from at least one publicly available on-line database. Additionally/alternatively, the crowd-source geographical data for the identified wireless coverage areas may be obtained from at least one proprietary third party database.

In one optional embodiment of the invention, the method may comprise receiving identifiers for the wireless coverage areas visible to the wireless communication unit as part of a periodic measurement reporting process. For example, the method may comprise receiving identifiers for the wireless coverage areas visible to the wireless communication unit as part of a cell selection/reselection process.

In one optional embodiment of the invention, the method may comprise receiving identifiers for wireless coverage areas comprising communication cells within a cellular communication system visible to the wireless communication unit.

According to a second aspect of the invention, there is provided a geolocation system arranged to perform geolocation of a wireless communication unit. The geolocation system comprises at least one signal processing module arranged to receive identifiers for at least two wireless coverage areas visible to the wireless communication unit, obtain crowd-sourced geographical data for the at least two identified wireless coverage areas, and calculate a geolocation estimate for the wireless communication unit based at least partly on the obtained crowd-sourced geographical data for the at least two identified wireless coverage areas.

According to a third aspect of the invention, there is provided a cellular communication system comprising the geolocation system of the second aspect of the invention.

According to a fourth aspect of the invention, there is provided a non-transitory computer program product having computer-readable code stored thereon for programming a signal processing module to perform a method for geolocating a wireless communication unit. The code is operable for receiving identifiers for at least two wireless coverage areas visible to the wireless communication unit, obtaining crowd-sourced geographical data for the at least two identified wireless coverage areas, and calculating a geolocation estimate for the wireless communication unit based at least partly on the obtained crowd-sourced geographical data for the at least two identified wireless coverage areas.

These and other aspects, features and advantages of the invention will be apparent from, and elucidated with reference to, the embodiments described hereinafter.

### BRIEF DESCRIPTION OF THE DRAWINGS

Embodiments of the invention will be described, by way of example only, with reference to the accompanying drawings, in which:

FIG. 1 illustrates an example of a simplified block diagram of a part of a cellular communication network.

FIG. 2 illustrates a simplified diagram of an example of refining a geolocation estimate.

FIG. 3 illustrates simplified flowchart of an example of a method for geolocating a wireless communication unit.

FIG. 4 illustrates a typical computing system that may be employed to implement processing functionality in embodiments of the invention.

### DETAILED DESCRIPTION OF EMBODIMENTS OF THE INVENTION

Examples of the invention will be described in terms of a method and apparatus for geolocating a wireless communication unit within a Universal Mobile Telecommunications System (UMTS™) cellular communication network. However, it will be appreciated by a skilled artisan that the inventive concept herein described may equally be implemented within cellular communication networks adapted in accordance with alternative wireless communication technologies and standards.

In a number of applications, the adaptation of a geolocation system in accordance with examples of the invention effectively performs a method for geolocating a wireless communication unit. The method comprises receiving identifiers for at least two wireless coverage areas visible to the wireless communication unit, obtaining crowd-sourced geographical data for the at least two identified wireless coverage areas, and calculating a geolocation estimate for the wireless communication unit based at least partly on the obtained crowd-sourced geographical data for the at least two identified wireless coverage areas.

As described in greater detail below, the use of crowd-sourced data in this manner enables a wireless communication unit to be geolocated without the requirement for additional dedicated hardware to be implemented within the cellular communication network, and without requiring GPS functionality to be available within the wireless communication unit. In addition, such a technique does not rely on measurements such as signal strength, timing data, etc. provided by the wireless communication units, which may sometimes be unreliable due to the wireless communication units being consumer grade devices built to a budget, and which typically do not undergo regular calibration. Furthermore, such a technique does not rely on network configuration data provided by the network operator; such data often being out of date or simply inaccurate.

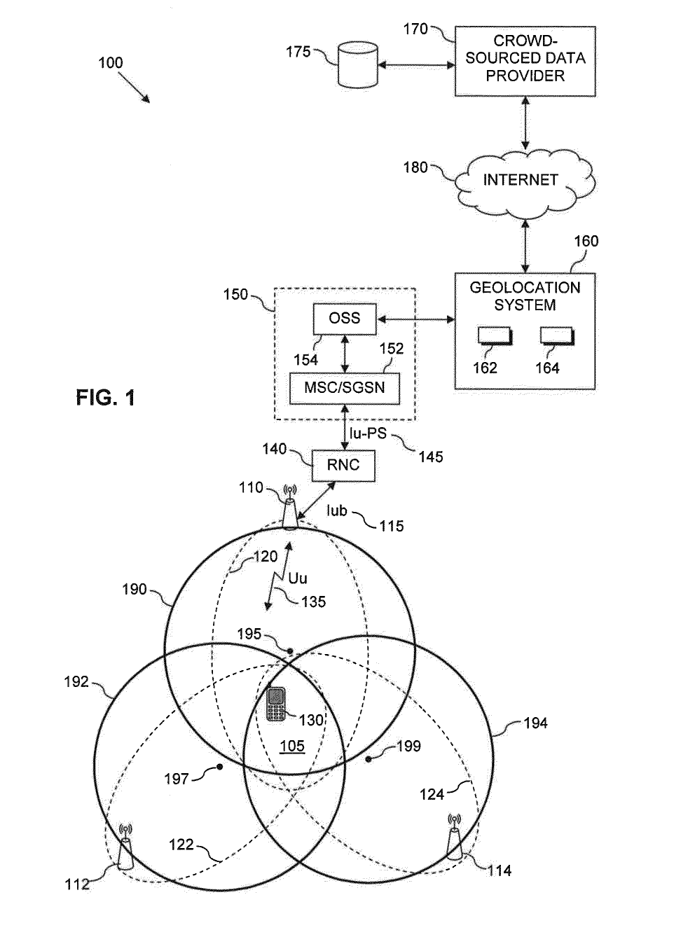

Referring now to the drawings, and in particular FIG. 1, an example of a simplified block diagram of a part of a cellular communication network is illustrated and indicated generally at 100. In FIG. 1, there is illustrated an example of a communication system in a form of a third generation partnership project (3GPP™) UMTS™ network 100 that comprises a plurality base stations, such as those illustrated at 110, 112, 114. Each base station 110, 112, 114 is arranged to support one or more communication sectors, also known as cells, such as illustrated at 120, 122, 124. In a typical UMTS network, there may exist a mix of macro, micro and femto cells comprising sectors of a range of different sizes. As such, it will be appreciated that the base stations 110, 112, 114 may comprise a mix of NodeBs and Home NodeBs (also known as femto access points). A wireless communication unit 130 located within a cell 120, 122, 124 is able to communicate with the base station 110, 112, 114 supporting that cell via an air interface (Uu) 135. Each base station 110, 112, 114 is operably coupled to a controller, such as the radio network controller (RNC) 140 to which the base station 110 is operably coupled via an lub interface 115. The RNC 140 is operably coupled to a core network 150 via an lu-PS interface 145. The core network 150 may comprise various network elements such as, in the illustrated example, one or more mobile switching centres (MSC) and/or Serving GPRS (General Packet Radio Service) Support Nodes (SGSN) 152 to which controllers such as the RNC 140 are operably coupled. The core network 150 in the illustrated example further comprises an operations support system (OSS) 154. The OSS 154 may be arranged to provide services such as maintaining network inventory, provisioning services, network component configuration, fault management, etc.

A geolocation system 160 is arranged to perform geolocation of wireless communication units within the UMTS network 100, and in the illustrated example is operably coupled to the OSS 160. Such a geolocation system 150 may comprise an external system managed by a third party independent from the network operator responsible for the UMTS network 100. However, it is also contemplated that such a geolocation system 150 may comprise an integral part of the UMTS network 100, and thus managed by the network operator. Accordingly, in some examples, the geolocation system 160 may for an integral part of, for example, the OSS 154.

In accordance with some example embodiments of the present invention, the geolocation system 160 is arranged to perform geolocation of wireless communication units within the cellular communication network 100. The geolocation system 160 comprises one or more signal processing modules, such as the signal processing module illustrated generally at 162, arranged to receive identifiers for a plurality of wireless coverage areas visible to a wireless communication unit to be geolocated, obtain crowd-sourced geographical data for the identified wireless coverage areas, and compute a geolocation for the wireless communication unit based at least partly on the obtained crowd-sourced geographical data for the identified wireless coverage areas. For example, the signal processing module 162 may be arranged to execute computer readable code stored within a memory element 164 arranged to program the signal processing module to perform a method for geolocating a wireless communication unit as herein described.

Within a UMTS network a wireless communication unit, such as the wireless communication unit 130 of FIG. 1, is typically configured to send measurement reports to, in the case of a macro cell architecture, the RNC 140 of the serving base station, for example base station 110, for cells included in an active set (i.e. those cells to which the wireless communication unit is currently connected) and cells included in a monitored set (i.e. those cells within a CELL_INFO_LIST broadcast by the network, not included in the active set). The wireless communication unit 130 may also be configured to send intra-frequency measurement reports for cells included in a detected set (i.e. those cells detected by the wireless communication unit but not included in the active or monitored sets). Such measurement reporting often forms part of a cell selection/reselection process, and may be periodic and/or event triggered.

Measurement reports sent from the wireless communication unit 130 to the RNC 140 may comprise measurements of link quality, signal strength, propagation delay, etc. for specific cells 120, 122, 124 identified therein. The information contained within the measurement reports, including the location area codes and cell identifiers for the respective cells, may be provided by the receiving RNC 140 to, in the illustrated example, the OSS 154, from where it may be made available to external systems, such as the geolocation system 160. Accordingly, such measurement reports provided to the RNC 140 may provide identifiers of wireless coverage areas comprising cells visible to the wireless communication unit. Advantageously, by utilising such measurement reports to provide identifiers of wireless coverage areas visible to a wireless communication unit, no additional air interface bandwidth is required.

Thus, when the geolocation system 160 is required to geolocated the wireless communication unit 130, the geolocation system 160 may receive identifiers of wireless coverage areas (e.g. cells) visible to the wireless communication unit 130 from the OSS 154 based on information provided by way of measurement reports received from the wireless communication unit 130. The geolocation system 160 may then obtain crowd-sourced geographical data for the identified wireless coverage areas.

Having received identifiers for wireless coverage areas, the geolocation system 160 may then obtain crowd-sourced geographical data for the identified wireless coverage areas. For example, crowd sourcing (the act of sourcing tasks to a large group of people or community (crowd)) has been used by various companies to build up location databases relating to, as an example, wireless coverage areas. Data obtained from large numbers of users of, for example, GPS enabled wireless communication units over an extended period of time enables wireless coverage areas to be associated with accurate geographical location data. For example, geographical location data obtained from a GPS enabled wireless communication unit may be associated with, for example, one or more identifiers (e.g. a location area code and cell identifiers for a UMTS cell, or a service set identifier—SSID in the case of a wireless local area network (WLAN)) representing wireless coverage areas to which the GPS enabled wireless communication unit is connected to, or which are visible to the GPS enabled wireless communication unit. Data obtained from large numbers of users of such units over an extended period of time may then be summarised to provide approximate geographical location data for each wireless coverage area for which data was received. For example, the geographical data associated with a particular wireless coverage area may be used to determine a geographical area for that particular wireless coverage area. The determined geographical area may then be represented by way of, for example, a centroid and radius therefor. Advantageously, by using geographical data provided by way of GPS enabled devices, accurate geographical data may be collected in relation to the wireless coverage areas. Furthermore, the use of crowd sourcing in this manner enables the data to be continuously updated.

Such crowd-sourced data may be available from a number of sources, such as one or more third party databases, for example such as databases maintained by Google™ Microsoft™ and Apple™, each of whom currently performs such crowd sourcing of location data. Such 3^{rd} party databases may be publicly accessible via, for example, the Internet. Alternatively, such databases may be proprietary and only available through subscription or some other arrangement with the proprietor thereof. For the illustrated example, the geolocation system 160 is illustrated as obtaining crowd-sourced geographical data from an on-line provider 170, over the Internet 180. For example, the geolocation system 160 may send a request to the on-line provider 170, via the Internet 180, for crowd-sourced geographical data for one or more identified wireless coverage areas; for example such a request comprising the location area code and cell identifier for the, or each, identified cell. Upon receipt of such a request, the crowd-sourced data provider 170 may retrieve the requested data from a database 175 and return the retrieved data to the geolocation system 160.

Having received the crowd-sourced geographical data for the identified wireless coverage areas, the geolocation system 160 may then estimate an area of overlap of the identified wireless coverage areas based on the received crowd-sourced data. For example, the wireless communication unit 130 of FIG. 1 is able to ‘see’ the cells 120, 122, 124 supported by each of the base stations 110, 112, 114. Accordingly, the wireless communication unit 130, which in the illustrated example is camped on the cell 120 supported by base station 110, sends measurement reports to the RNC 140 for each of the cells 120, 122, 124. Accordingly, in order to geolocated the wireless communication unit 130, the geolocation system 160 may obtain crowd-sourced geographical data from the crowd-sourced data provider 170 for the cells 120, 122, 124. The crowd-sourced geographical data may comprise, for each cell 120, 122, 124, an indication of a geographical location representative of a central point within the cell 120, 122, 124, such as the centroid therefor, illustrated at 195, 197, 199. The crowd-sourced geographical data may further comprise, for each cell 120, 122, 124, an indication of a radius of the cell 120, 122, 124. Thus, for the illustrated example a substantially circular geographical area 190, 192, 194 may be defined for each cell 120, 122, 124 using the obtained crowd-sourced geographical data. It will be appreciated that the crowd-sourced data may comprise data defining the generally geographical coverage area of cells in alternative formats, for example in the form of longitude and latitude co-ordinates of a number of points defining an approximate area of coverage. Accordingly, the geographical area defined by the crowd-sourced data for a cell may be other than generally circular.

An area of overlap of the identified wireless coverage areas (i.e. of the cells 120, 122, 124) may then be estimated by calculating an area of overlap for the geographical areas 190, 192, 194 defined by the crowd-sourced geographical data. This area of overlap, illustrated generally at 105, may then be set as a geolocation area for the wireless communication unit 130, and a geolocation estimate for the wireless communication unit may be calculated based on this geolocation area 105 for the wireless communication unit 130.

For example, the geolocation system 160 may be arranged to determine a geolocation estimate for the wireless communication unit 130 by calculating a central point of the geolocation area 105, and setting this central point as the geolocation estimate for the wireless communication unit 130. Conversely, the geolocation system 160 may be arranged to select a substantially arbitrary point within the geolocation area 105 and to set this selected point as the geolocation estimate for the wireless communication unit 130. Advantageously, using an arbitrary point within the geolocation area 105 as the geolocation estimate for the wireless communication unit 130 enables a more even spread of geolocation estimates within their respective geolocation areas 105 when accumulating a plurality of geolocation estimates to produce an overall representation of wireless communication unit geolocations. For example, a point within the geolocation area 105 may be selected using, say, a monte carlo algorithm. Thus, a technique for geolocating a wireless communication unit 130 has been described which uses crowd-sourced data for wireless coverage areas visible to the wireless communication unit. Advantageously, because such crowd-sourced data is typically based on a large amount of collated data based on, for example, GPS data, the crowd-sourced geographical data for each wireless coverage area upon which a geolocation estimate is based is typically reliable and accurate. Furthermore, such data is typically continuously updated, thereby ensuring the reliability and accuracy is maintained.

In addition, although the crowd-sourced geographical data for each wireless coverage area may be accurate with regard to, for example, the centroid and radius therefor; the granularity available for each individual wireless coverage area is limited to the radius therefor, and thus is relatively coarse. However, by calculating a geolocation estimate for the wireless communication unit based on the obtained crowd-sourced geographical data for two or more identified wireless coverage areas, a finer granularity may be achieved.

In accordance with some alternative embodiments of the present invention, the geolocation system 160 may further be arranged to refine the geolocation estimate based on, for example, measurements for the identified wireless coverage areas provided by the wireless communication unit 130. For example, as mentioned above, in a UMTS network the wireless communication unit 130 is arranged to send measurement reports to the RNC 140 of the serving base station 110 for cells within at least a monitored set and an active set of cells. Measurement reports sent from the wireless communication unit 130 to the RNC 140 may comprise measurements of link quality, signal strength, propagation delay, etc. for specific cells 120, 122, 124 identified therein. Accordingly, it is contemplated that such measurements may be used to refine the geolocation estimate for the wireless communication unit 130.

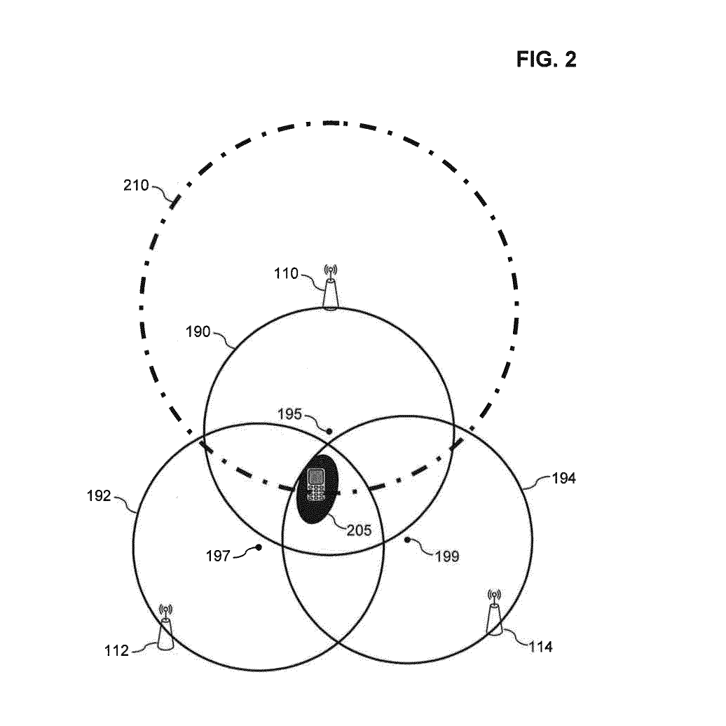

FIG. 2 illustrates a simplified diagram of an example of refining a geolocation estimate for the wireless communication unit 130 using such measurements for the identified wireless coverage areas provided by the wireless communication unit 130. For example, the geolocation system 160 may further be arranged to refine the geolocation estimate for the wireless communication unit 130 within the geolocation area 105 based at least partly on signal strength measurements for one or more of the wireless coverage areas. Specifically, a high signal strength reported from the wireless communication unit 130 for a given coverage area may be interpreted as the wireless communication unit 130 being located closer to the base station for that coverage are than would a lower reported signal strength. If the location of the base station itself is known, for example by way of network configuration data available from the network operator, or alternatively from a public database containing such location information, such as that maintained by OFCOM (Office of Communications) in the UK, then by comparing the signal strengths for the identified wireless coverage areas, and the locations of their respective base stations, an approximate location of the wireless communication unit 130 within the geolocation area 105 may be calculated, and used to refine the geolocation area to comprise a smaller area, such as illustrated at 205. In this manner, a refined geolocation estimate for the wireless communication unit 130 may be derived based on this refined geolocation area 205 for the wireless communication unit 130.

Additionally/alternatively, the geolocation system 160 may further be arranged to refine the geolocation estimate for the wireless communication unit 130 within the geographical area 105 based at least partly on link quality measurements for one or more of the wireless coverage areas. For example, in a similar manner to the signal strength example outlined above, a link quality measurement, such as Ec/N0 in the case of a UMTS system, may be used to estimate how close to the respective base station 110, 112, 114 the wireless communication unit 130 is likely to be; a better (higher) Ec/N0 figure indicating that the wireless communication unit 130 is likely to be closer to a base station than for a poorer (lower) figure. Accordingly, if the location of the base station itself is known, for example by way of network configuration data available from the network operator, or alternatively from a public database containing such location information, then by comparing the link quality measurements for the identified wireless coverage areas, and the locations of their respective base stations, an approximate location of the wireless communication unit 130 within the geolocation area 105 may be calculated, and used to (further) refine the geolocation area to comprise a smaller area 205. In this manner, a refined geolocation estimate for the wireless communication unit 130 may be derived based on this refined geolocation area 205 for the wireless communication unit 130.

Additionally/alternatively, the geolocation system 160 may further be arranged to refine the geolocation estimate for the wireless communication unit 130 within the geographical area 105 based at least partly on propagation delay measurements for one or more of the wireless coverage areas. For example, the propagation delay reported by the wireless communication unit 130 for a given wireless coverage area is a direct indication of how far the wireless communication unit 130 is from the transmitter (e.g. base station) for that wireless coverage area; the longer the propagation delay, the further from the base station the wireless communication unit is located. Radio signals travel at the speed of light (C˜3×10̂8 m/s), hence every microsecond of reported propagation delay corresponds to approximately 300 m of distance from the respective base station, or 150 m if the propagation delay reported is the ‘round-trip’ propagation delay, i.e. the delay in a signal getting from the wireless communication unit 130 to the base station and a response returning to the wireless communication unit 130 (ignoring any processing delay at the base station). Accordingly, if the location of the base station itself is known, for example by way of network configuration data available from the network operator, or alternatively from a public database containing such location information, the approximate distance from the base station to the wireless communication unit 130 can be used to further refine the geolocation estimate for that wireless communication unit 130. For example, as illustrated in FIG. 2, using the propagation delay measurements provided by the wireless communication unit 130 for the base station 110, an approximate distance between the base station 110 and the wireless communication unit 130 may be calculated, as illustrated generally by the circle 210. A (further) refined geolocation estimate may thus be derived by selecting as the geolocation estimate a point within the (refined) geolocation area 105/205, and located within a limited distance of this circle 210 representative of the distance between the wireless communication unit 130 and the base station 110.

For the examples herein before described with reference to FIGS. 1 and 2, the present invention has been described using wireless coverage areas comprising cells or sectors within a cellular communication network. However, it is contemplated that crowd-sourced geographical data for alternative types of wireless coverage areas may equally be used for calculating geolocation estimates for wireless communication units. For example, may wireless communication units adapted for use with, for example, UMTS networks, are also adapted to connect to wireless local area networks (WLANs), also known as ‘Wifi hotspots’. Accordingly, it is contemplated that wireless coverage areas for which crowd-sourced data may be used to calculate geolocation estimates for wireless communication units may additionally/alternatively comprise such WLAN coverage areas. The locations of such ‘hot spots’ are often available on public databases for other purposes, for example to allow potential users of such ‘hot spots’ to be able to locate them.

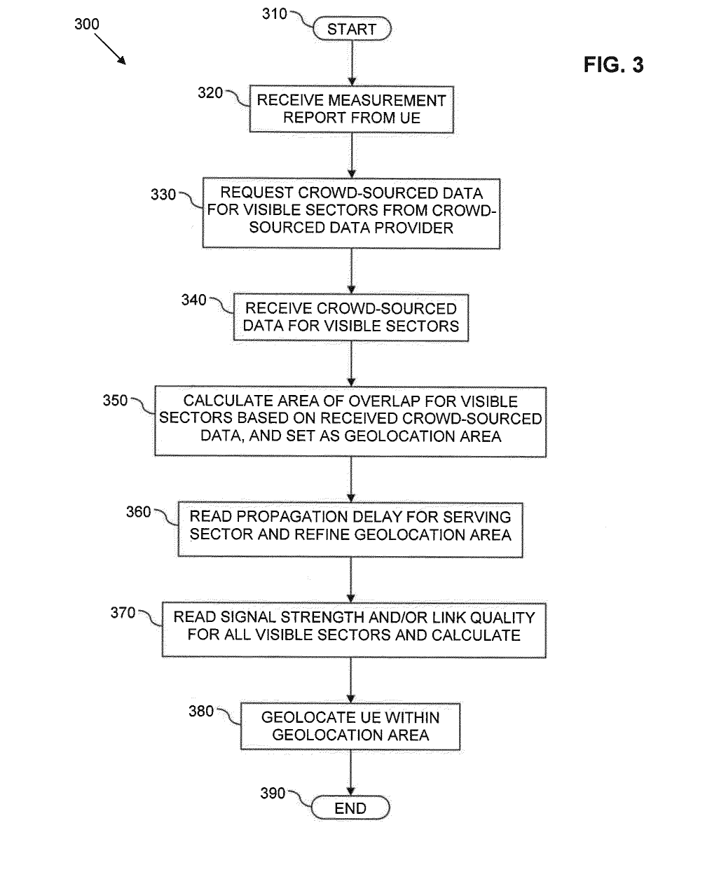

Referring now to FIG. 3, there is illustrated a simplified flowchart 300 of an example of a method for geolocating a wireless communication unit, such as may be implemented within the geolocation system 160 of FIG. 1. The method starts at 310 and moves on to 320 with the receipt of identifiers and measurements (e.g. signal strength, link quality and propagation delay measurements) for at least two wireless coverage areas visible to the wireless communication unit. Next, at 440, crowd-sourced data for the identified wireless coverage areas is requested from one or more crowd-sourced data providers. Upon receipt of the requested crowd-sourced data, at 340, the method moves on to 350 where an area of overlap for the identified wireless coverage areas is estimated based on the received crowd-sourced data, and set as a geolocation area. The geolocation area is then refined using the received measurements, and in particular in the illustrated example using propagation delay measurements at 360 and signal strength and/or link quality measurements at 370. A geolocation estimate for the wireless communication unit is then calculated based on this geolocation area at 380, and the method ends at 390.

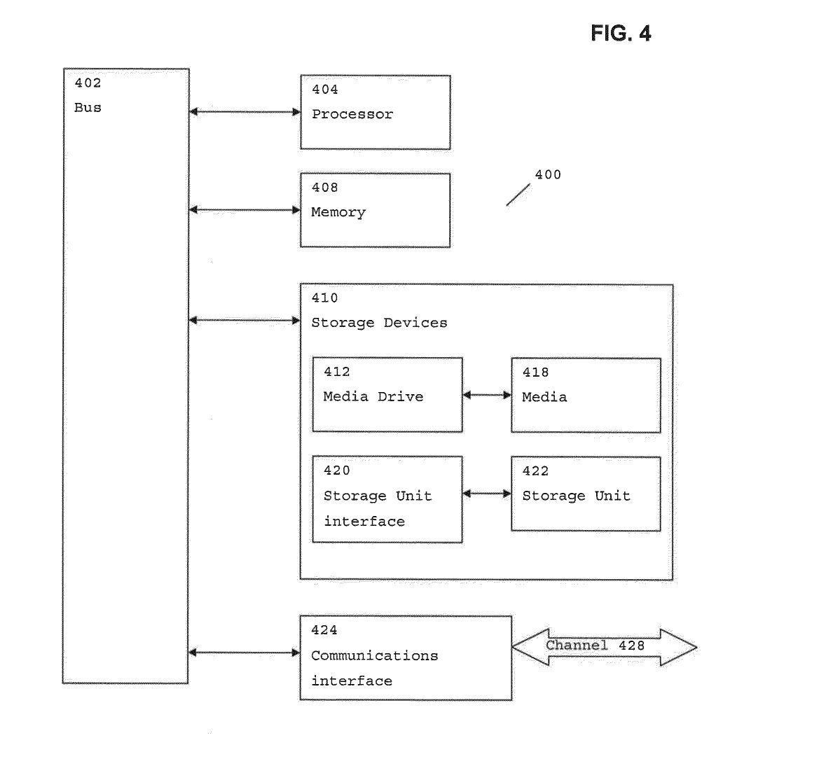

Referring now to FIG. 4, there is illustrated a typical computing system 400 that may be employed to implement signal processing functionality in embodiments of the invention. For example, a computing system of this type may be used within the geolocation system 160 of FIG. 1. Those skilled in the relevant art will also recognize how to implement the invention using other computer systems or architectures. Computing system 400 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 400 can include one or more processors, such as a processor 404. Processor 404 can be implemented using a general or special-purpose processing engine such as, for example, a microprocessor, microcontroller or other control module. In this example, processor 404 is connected to a bus 402 or other communications medium.

Computing system 400 can also include a main memory 408, such as random access memory (RAM) or other dynamic memory, for storing information and instructions to be executed by processor 404. Main memory 408 also may be used for storing temporary variables or other intermediate information during execution of instructions to be executed by processor 404. Computing system 400 may likewise include a read only memory (ROM) or other static storage device coupled to bus 402 for storing static information and instructions for processor 404.

The computing system 400 may also include information storage system 410, which may include, for example, a media drive 412 and a removable storage interface 420. The media drive 412 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 418 may include, for example, a hard disk, floppy disk, magnetic tape, optical disk, CD or DVD, or other fixed or removable medium that is read by and written to by media drive 412. As these examples illustrate, the storage media 418 may include a computer-readable storage medium having particular computer software or data stored therein.

In alternative embodiments, information storage system 410 may include other similar components for allowing computer programs or other instructions or data to be loaded into computing system 400. Such components may include, for example, a removable storage unit 422 and an interface 420, such as a program cartridge and cartridge interface, a removable memory (for example, a flash memory or other removable memory module) and memory slot, and other removable storage units 422 and interfaces 420 that allow software and data to be transferred from the removable storage unit 418 to computing system 400.

Computing system 400 can also include a communications interface 424. Communications interface 424 can be used to allow software and data to be transferred between computing system 400 and external devices. Examples of communications interface 424 can include a modem, a network interface (such as an Ethernet or other NIC card), a communications port (such as for example, a universal serial bus (USB) port), a PCMCIA slot and card, etc. Software and data transferred via communications interface 424 are in the form of signals which can be electronic, electromagnetic, and optical or other signals capable of being received by communications interface 424. These signals are provided to communications interface 424 via a channel 428. This channel 428 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’ ‘computer-readable medium’ and the like may be used generally to refer to media such as, for example, memory 408, storage device 418, or storage unit 422. These and other forms of computer-readable media may store one or more instructions for use by processor 404, to cause the processor to perform specified operations. Such instructions, generally referred to as ‘computer program code’ (which may be grouped in the form of computer programs or other groupings), when executed, enable the computing system 400 to perform functions of embodiments of the present invention. Note that the code may directly cause the processor to perform specified operations, be compiled to do so, and/or be combined with other software, hardware, and/or firmware elements (e.g. libraries for performing standard functions) to do so.

As used herein, the expression non-transitory will be understood to refer to the non-ephemeral nature of the storage medium itself rather than to a notion of how long the stored information itself may persist in a stored state. Accordingly, memories that might otherwise be viewed, for example, as being volatile (such as many electronically-erasable programmable read-only memories (EPROM's) or random-access memories (RAM's)) are nevertheless to be viewed here as being “non-transitory” whereas a signal carrier in transit is to be considered “transitory” notwithstanding that the signal may remain in transit for a lengthy period of time.

In an embodiment where the elements are implemented using software, the software may be stored in a computer-readable medium and loaded into computing system 400 using, for example, removable storage drive 422, drive 412 or communications interface 424. The control module (in this example, software instructions or computer program code), when executed by the processor 404, causes the processor 404 to perform the functions of the invention as described herein.

Furthermore, the inventive concept can be applied to any signal processing circuit. It is further envisaged that, for example, a semiconductor manufacturer may employ the inventive concept in a design of a stand-alone device, such as a microcontroller, digital signal processor, or application-specific integrated circuit (ASIC) and/or any other sub-system element.

It will be appreciated that, for clarity purposes, the above description has described embodiments of the invention with reference to different functional units and processors. However, it will be apparent that any suitable distribution of functionality between different functional units or processors may be used without detracting from the invention. For example, functionality illustrated to be performed by the same processor or controller may be performed by separate processors or controllers. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices. Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Thus, an improved method and apparatus for geolocating a wireless communication unit have been described, wherein the aforementioned disadvantages with prior art arrangements have been substantially alleviated.

1. A method for geolocating a user equipment, the method comprising:
receiving identifiers for at least two wireless coverage areas visible to the user equipment;
obtaining crowd-sourced coverage for the at least two identified wireless coverage areas; and
calculating a geolocation estimate for the user equipment based at least partly on the obtained crowd-sourced coverage for the at least two identified wireless coverage areas.

2. The method of claim h wherein the method comprises calculating an area of overlap of the wireless coverage areas based on the crowd-sourced coverage therefor, and determining a geolocation estimate for the user equipment within the area of overlap.

3. The method of claim 2, wherein the method comprises determining a geolocation estimate for the user equipment to be a central point within the overlap of the wireless coverage areas.

4. The method of claim 2, wherein the method comprises determining a geolocation estimate for the user equipment to be an arbitrary point within the overlap of the wireless coverage areas.

5. The method of claim 1, wherein the method further comprises refining a geolocation estimate for the user equipment using measurements for at least one of the identified wireless coverage areas provided by the user equipment

6. The method of claim 5, wherein the method comprises receiving signal strength information from the user equipment for at least one of the identified wireless coverage areas, and refining the geolocation estimate for the user equipment within the area of overlap based at least partly on the received signal strength information.

7. The method of claim 5, wherein the method comprises receiving link quality information from the user equipment for at least one of the identified wireless coverage areas, and refining the geolocation estimate for the user equipment within the area of overlap based at least partly on the received link quality information.

8. The method of claim 5, wherein the method further comprises:
receiving propagation delay information from the user equipment for at least one of the identified wireless coverage areas;
estimating a distance between the user equipment and a transmitter of each of the identified wireless coverage areas for which propagation delay information is received; and
refining the geolocation estimate for the user equipment within the area of overlap based at least partly on the estimated distance(s).

9. The method of claim 1, wherein the crowd-sourced coverage for the identified wireless coverage areas comprises, for each wireless coverage area:
an indication of a geographical location representative of a central point within the wireless coverage area; and
an indication of a radius of the wireless coverage area.

10. The method of claim h wherein the crowd-sourced coverage for the identified wireless coverage areas is obtained from at least one third party database.

11. The method of claim 10, wherein the crowd-sourced coverage for the identified wireless coverage areas is obtained from at least one publicly available on-line database.

12. The method of claim 10, wherein the crowd-source coverage for the identified wireless coverage areas is obtained from at least one proprietary third party database.

13. The method of claim h wherein the method comprises receiving identifiers for the wireless coverage areas visible to the user equipment as part of a periodic measurement reporting process.

14. The method of claim 13, wherein the method comprises receiving identifiers for the wireless coverage areas visible to the user equipment as part of a cell selection/reselection process.

15. The method of claim 1, wherein the method comprises receiving identifiers for wireless coverage areas comprising communication cells within a cellular communication system visible to the user equipment.

16. A geolocation system arranged to perform geolocation of a user equipment, the geolocation system comprising at least one signal processing module arranged to:
receive identifiers for at least two wireless coverage areas visible to the user equipment;
obtain crowd-sourced coverage for the at least two identified wireless coverage areas; and
calculate a geolocation estimate for the user equipment based at least partly on the obtained crowd-sourced coverage for the at least two identified wireless coverage areas.

17. A cellular communication system comprising a geolocation system in accordance with claim 16.

18. A non-transitory computer program product having computer-readable code stored thereon for programming a signal processing module to perform a method for geolocating a user equipment, the code operable for:
receiving identifiers for at least two wireless coverage areas visible to the user equipment;
obtaining crowd-sourced coverage for the at least two identified wireless coverage areas; and
calculating a geolocation estimate for the user equipment based at least partly on the obtained crowd-sourced coverage for the at least two identified wireless coverage areas.

19. A non-transitory computer program product of claim 18, wherein the non-transitory computer program product comprises at least one of a hard disk, a CD-ROM, an optical storage device, a magnetic storage device, a Read Only Memory, ROM, a Programmable Read Only Memory, PROM, an Erasable Programmable Read Only Memory EPROM, EPROM, an Electrically Erasable Programmable Read Only Memory, EEPROM, and a Flash memory.
